(19) United States
(12) Patent Application Publication
(10) Pub. No.: US 2012/0295045 A1
(43) Pub. Date: Nov. 22, 2012

(54) HOUSING FOR ELECTRONIC DEVICE AND METHOD FOR MANUFACTURING THE SAME

(75) Inventors: CHAO TANG, Shenzhen City (CN); SHENG-CHANG QIN, Shenzhen City (CN); ZHONG-JIE LUO, Shenzhen City (CN); JIAN-HUI DAI, Shenzhen City (CN); YU-TAO CHEN, Tu-Cheng (TW); TE-SHENG JAN, Tu-Cheng (TW); CHUN-CHE YEN, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/224,303

(22) Filed: Sep. 1, 2011

(30) Foreign Application Priority Data
May 16, 2011 (CN) 201110125672.1

(51) Int. Cl. B32B 15/00; B32B 38/00

(52) U.S. Cl. 428/35.7; 264/135

(57) ABSTRACT

A method of manufacturing a housing includes steps of providing a transparent film including a first surface and an opposing second surface. Forming a patterned layer on the first surface of the transparent film, forming a metallic film layer on the first surface of the transparent film to cover the patterned layer, applying an adhesive material on the metallic film. Then placing the transparent film in the mold, the second surface of the transparent film attached to the inner molding surface of the mold. And at last injecting plastic material into the mold to form a plastic base adhered with the transparent film. The housing can have both predetermined patterns and metallic luster.

### BACKGROUND

1. Technical Field

The present disclosure relates to housings, particularly to a housing for electronic devices and a method of manufacturing the housing.

2. Description of Related Art

The external appearance of the housing of the portable electronic devices (such as mobile telephones and electronic notebooks) has become a key factor for attracting consumers.

In-Mold Labeling (IML) process is a typical method to produce such decorative plastic housing. The process is carried out by molding a plastic substrate to combine with a plastic film in a mold. Prior to the substrate being molded, a predetermined pattern, text, or picture is printed on the film. The molded substrate is then combined with the patterned film. The pattern may not be abraded or eroded because it is located between the film and the substrate. However, a coating with metallic luster cannot be formed on the substrate in this manner.

Another method to produce such decorative plastic housings is physical vapor deposition (PVD) process PVD is a process of depositing thin films by the condensation of a vaporized form of the material onto various surfaces. In this way, a metallic film can be deposited on a surface of a substrate, and the substrate can render great metallic luster. Nevertheless, the operator cannot form patterns text, or pictures on the substrate via PVD process. Furthermore, after depositing a metallic film on the substrate, a coating of protecting layer is deposited on the plastic substrate and the thickness of the housing increases. The coating area is large the protection layer and is easily to scratch and crack. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled, isometric view of an electronic device in accordance with an exemplary embodiment.

FIG. 2 is schematic cross-sectional views illustrating a housing of the electronic device according to a first embodiment.

FIG. 3 is a flowchart of a process of manufacturing a housing of the electronic device according to the first embodiment.

FIG. 4 is schematic cross-sectional views illustrating a housing of the electronic device according to a second embodiment.

FIG. 5 is a flowchart of a process of manufacturing a housing of the electronic device according to the second embodiment.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

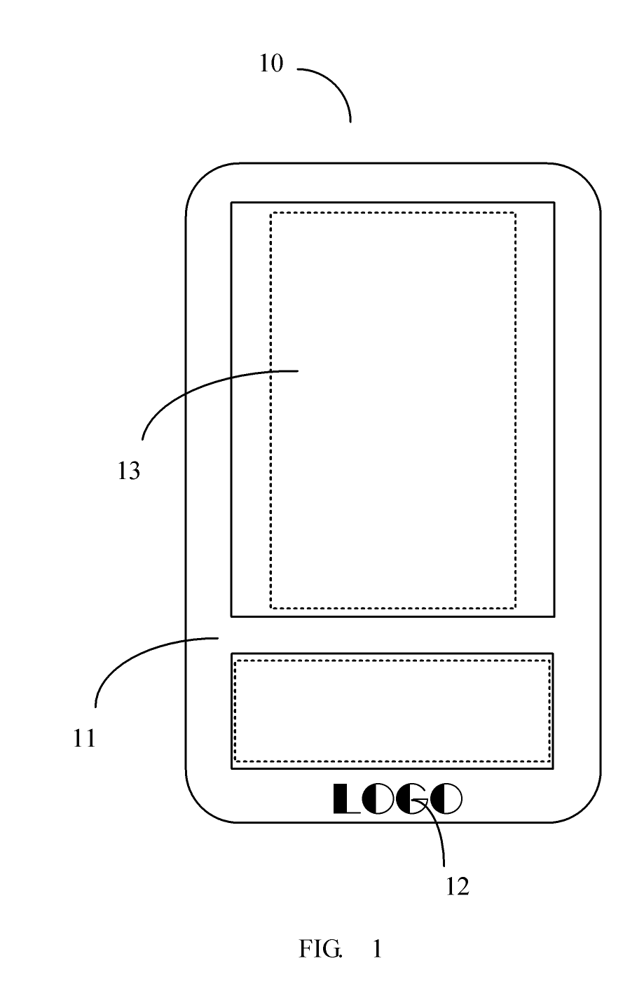

Referring to FIG. 1, an electronic device 10 is illustrated. The electronic device 10 can be a digital photo frame (DPF), an E-paper reading device, a MP3 or a cell phone. The electronic device 10 includes a housing 11 and a screen 13.

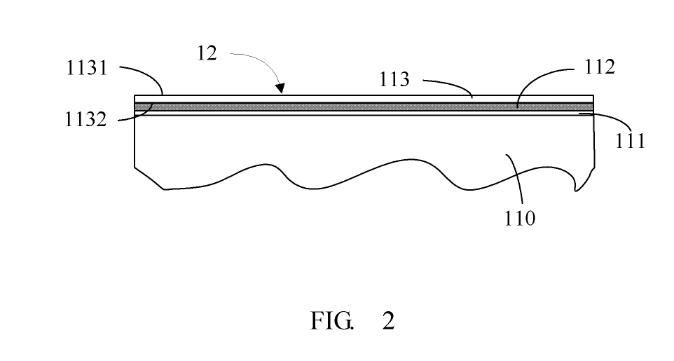

Referring to FIG. 2, a first embodiment of the housing 11 of the electronic device 10 is illustrated. The housing 11 includes a plastic base 110 and a decorative pattern layer 12 attached on the plastic base 110. In the first embodiment, the decorative pattern layer 12 includes a transparent cover layer 113, a metallic film layer 112 and an adhesive layer 111 combining the plastic base 110 and the decorative pattern layer 12 together.

The cover layer 113 may be made of a material selected from the group consisting of polyisoprene (PI), polycarbonate (PC), or polyethylene terephthalate (PET), and any suitable combination thereof. The thickness of the cover layer 113 is about 0.1 to about 0.5 mm. The cover layer 113 includes a first surface 1131 and an opposing second surface 1132.

The metallic film layer 112 is deposited on the first surface 1131 of the cover layer 113 via physical vapor deposition (PVD) process, the metallic film layer 112 causes the housing 11 to render a metallic luster.

The adhesive layer 111 is made of hot melt adhesive. The adhesive layer 111 is printed or coated on the metallic film layer 112, to combine the plastic base 110 and the decorative pattern layer 12.

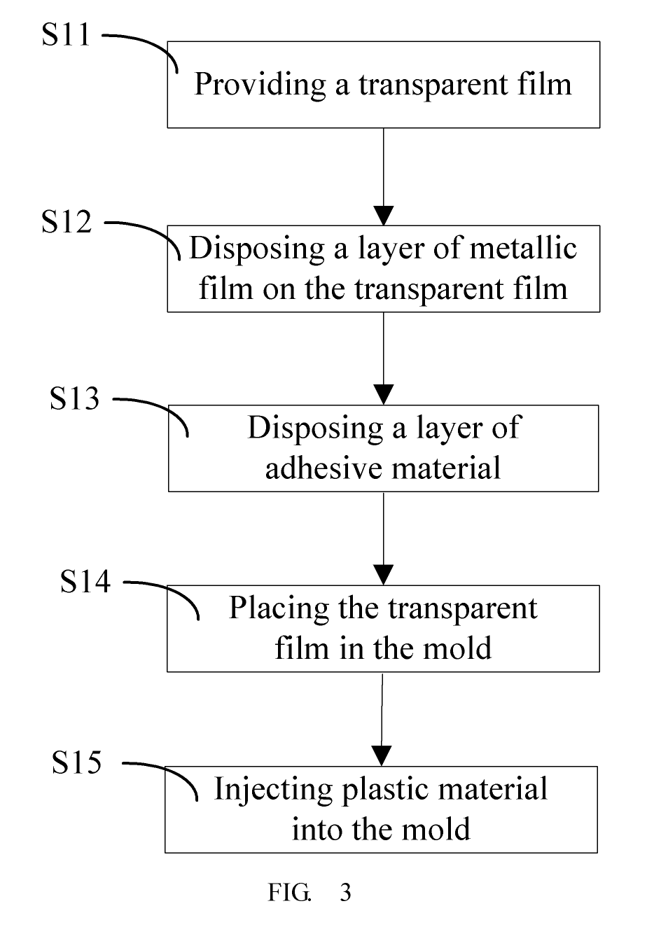

Referring to FIG. 3, a flowchart of a process of manufacturing the housing 11 according to the first embodiment is illustrated.

In step S11, providing a transparent film including a first surface and an opposing second surface. The transparent film may be made of a material selected from the group consisting of polyisoprene (PI), polycarbonate (PC), or polyethylene terephthalate (PET), and any suitable combination thereof. The thickness of the transparent film is about 0.1 to about 0.5 mm.

In step S12, forming a metallic film on the first surface of the transparent film. The metallic film can be deposited on the first surface of the transparent film using physical vapor deposition (PVD) process.

In step S13, applying adhesive material on the metallic film to form an adhesive layer 111 on the metallic film, the second surface is free of the adhesive material thereon.

In step S14, placing the treated transparent film in a mold, and the second surface of the transparent film attached to the inner molding surface of the mold. In other embodiments, the transparent film is cut to a predetermined shape prior to being placed in the mold.

In step S15, injecting plastic material into the mold to form a plastic base 110 overlaid with the transparent film. During the injection molding process, the plastic material forms the plastic base 110 overlaid with the transparent film. The transparent film forms the cover layer 112. The transparent film is combined with the plastic base 110 by the heat-fusing function of the adhesive material.

In the first embodiment, the metallic film layer 112 is deposited on the surface of the cover layer 113 by PVD process, and then combined with the plastic base 110 by IML process. Thus, solving the problem of the surface scratching and the ink contraction of the protection layer in the method described in the related art. Furthermore, the cover layer 113 is adhered securely to the plastic base 110 with the heat-fusing function of the adhesive material.

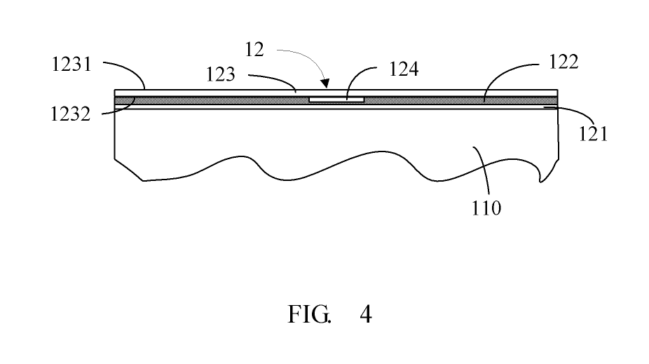

Referring to FIG. 4, a second embodiment of the housing 11 of the electronic device 10 is illustrated. In the second embodiment, the decorative pattern layer 12 includes a transparent cover layer 123, a pattern layer 124, a metallic film layer 122 and an adhesive layer 121. The cover layer 123 includes a first surface 1231 and an opposing second surface 1232. The pattern layer 124 is a logo.

A predetermined decorative pattern, text or image can be printed on the predetermined regions of the first surface 1231 of the cover layer 123 to form the pattern layer 124.

The metallic film layer 122 is deposited on the first surface 1231 of the cover layer 123 to cover the pattern layer 124 with physical vapor deposition (PVD) process. The pattern layer 124 is arranged between the metallic film layer 122 and the cover layer 123. The metallic film layer 122 causes the housing 11 to render a metallic luster.

The adhesive layer 121 is hot-melt adhesive. The adhesive layer 121 is printed or coated on the metallic film layer 122, to combine the plastic base 110 and the decorative pattern layer 12.

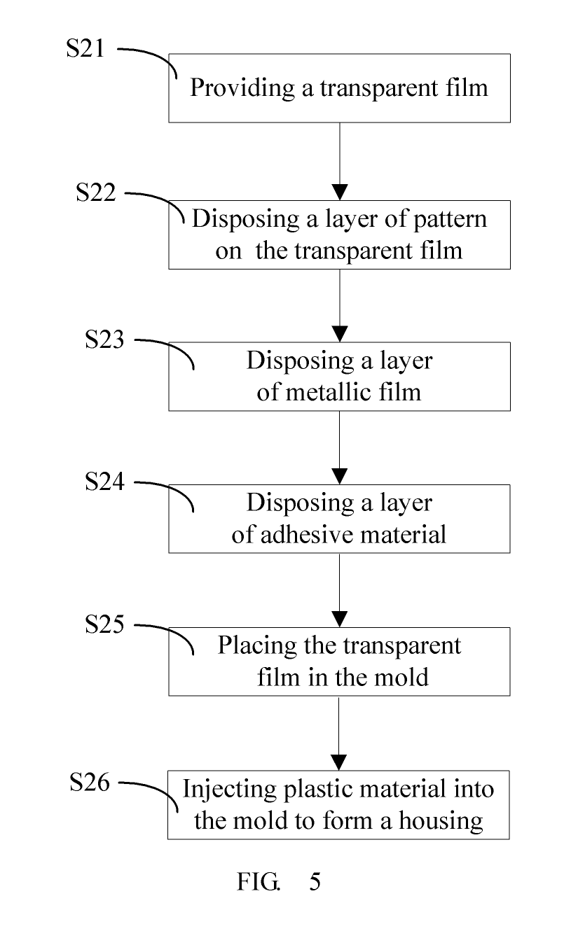

Referring to FIG. 5, a flowchart of a process of manufacturing the housing 11 according to the second embodiment is illustrated.

In step S21, providing a transparent film including a first surface and an opposing second surface. The transparent film may be made of a material selected from the group consisting of polyisoprene (PI), polycarbonate (PC), or polyethylene terephthalate (PET), and any suitable combination thereof. The thickness of the transparent film is about 0.1 to about 0.5 mm.

In step S22, applying a pattern layer on the first surface of the transparent film. A predetermined decorative pattern, text or image can be printed on the predetermined regions of the first surface of the transparent film to form the pattern layer 124.

In step S23, applying a metallic film layer on the first surface of the transparent film. The metallic film can be deposited on the first surface of the transparent film to cover the pattern layer with physical vapor deposition (PVD) process.

In step S24, applying adhesive material on the metallic film layer to form an adhesive layer 121 on the metallic film, the second surface is free of the adhesive material thereon.

In step S25, placing the treated transparent film in a mold, and the second surface of the transparent film attached to the inner molding surface of the mold. In other embodiment, the transparent film is cut to a predetermined shape prior to being placed in the mold.

In step S26, injecting plastic material into the mold to form a plastic base 120 overlaid with the transparent film. During the injection molding process, the plastic base 110 is formed overlaid with the transparent film. The transparent film forms the cover layer 122. The transparent film is combined with the plastic base 110 by the heat-fusing function of the adhesive material, and forms the adhesive layer 121.

In the first embodiment, the housing 11 both has the pattern layer 124 and the metallic film layer 122, the housing can have both, predetermined patterns and metallic luster. The pattern layer 124 and the metallic film layer 122 may not be sensed or be abraded because it is located between the plastic base 110 and the cover layer 123. Likewise, the housing 11 and the method of manufacturing the housing 11 in the second embodiment, solves the problem of the surface scratching and ink contraction of the protecting layer in the method of depositing a metallic film on the plastic base 110 with PVD process directly in the related art.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A method of manufacturing a housing, comprising:
providing a transparent film comprising a first surface and an opposing second surface;
forming a metallic film on the first surface of the transparent film;
applying adhesive material on the metallic film to form an adhesive layer on the metallic film, the second surface of the transparent film being free of the adhesive material thereon;
placing the treated transparent film in a mold, the molding including an inner molding surface, the second surface of the transparent film attached to the inner molding surface of the mold; and
injecting plastic material into the mold to form a plastic base overlaid with the transparent film, the adhesive layer sandwiched between the plastic base and the transparent film.

2. The method according to claim 1, wherein the metallic film is formed on the first surface of the transparent film using a physical vapor deposition process.

3. The method according to claim 1, further comprising cutting the transparent film to a predetermined shape prior to placing the treated transparent film in the mold.

4. The method according to claim 1, wherein the transparent film is made of a material selected from the group consisting of polyisoprene, polycarbonate, and polyethylene terephthalate.

5. The method according to claim 1, wherein the thickness of the transparent film is in the range from 0.1 mm to 0.5 mm.

6. The method according to claim 1, wherein the adhesive material is hot melt adhesive material.

7. A method of manufacturing a housing, comprising:
providing a transparent film comprising a first surface and an opposing second surface;
forming a pattern layer on the first surface of the transparent film;
forming a metallic film on the first surface of the transparent film to cover the pattern layer;
applying adhesive material on the metallic film to form an adhesive layer on the metallic film, the second surface of the transparent film being free of the adhesive material thereon;
placing the treated transparent film in a mold, the molding including an inner molding surface, the second surface of the transparent film attached to the inner molding surface of the mold; and
injecting plastic material into the mold to form a plastic base overlaid with the transparent film, the adhesive layer sandwiched between the plastic base and the transparent film.

8. The method according to claim 7, wherein the metallic film is formed on the first surface of the transparent film using a physical vapor deposition process.

9. The method according to claim 7, further comprising cutting the transparent film to a predetermined shape prior to placing the transparent film in the mold.

10. The method according to claim 7, wherein the thickness of the treated transparent film is in the range from 0.1 mm to 0.5 mm.

11. The method according to claim 7, wherein the adhesive material is hot melt adhesive material.

12. A plastic housing, comprising:
a plastic base;
a transparent cover layer attached on the plastic base; and
a pattern layer formed on a surface of the transparent cover layer and arranged between the plastic base and the transparent cover layer;
a metallic film formed on the transparent cover layer to cover the pattern layer.

13. The housing according to claim 12, wherein the thickness of the transparent cover layer is in the range from 0.1 mm to 0.5 mm.

14. The housing according to claim 12, wherein an adhesive layer is arranged between the plastic base and the transparent cover layer to adhere the transparent cover layer on the surface of the plastic base.

15. The housing according to claim 14, wherein the adhesive layer is made of hot melt adhesive material.
